(19) United States
(12) Patent Application Publication
(10) Pub. No.: US 2026/0336534 A1
(43) Pub. Date: Oct. 29, 2026

(54) ROOF ASSEMBLY WITH ROOF PANEL ELEMENT AND HEADLINER

(71) Applicant: Webasto SE, Stockdorf (DE)

(72) Inventor: Thomas SCHRÖFERL, Stockdorf (DE)

(21) Appl. No.: 19/654,029

(22) Filed: Apr. 21, 2026

(30) Foreign Application Priority Data
Apr. 23, 2025 (DE) 10 2025 115 650.6

(51) Int. Cl. B60R 13/02

(52) U.S. Cl. CPC B60R 13/0231

(57) ABSTRACT

A vehicle roof assembly having a roof panel with a circumferential edge foam and to the inner side of which, facing a vehicle interior, an inner cover panel is attached, which has at least one leg which extends in the transverse direction of the roof and which has a first edge located on the outside relative to the center of the panel element, which first edge is received by the edge foam, and a second edge located on the inside relative to the center of the panel element, which second edge is exposed opposite the edge foam, further having a headliner with a headliner element that forms a visible surface facing a vehicle interior and is spaced apart from the inner side of the roof panel element by an edge gap. A trim profile is mounted on the second, inner edge of the leg of the inner cover panel.

### CROSS-REFERENCE TO RELATED APPLICATION

This application claims the benefit of German patent Application No. 10 2025 115 650.6 filed Apr. 23, 2025, which is incorporated herein by reference in its entirety.

### TECHNICAL FIELD

This disclosure relates generally to a roof assembly for a motor vehicle.

### BACKGROUND

Roof assemblies are known from the prior art and are in particular a component of a passenger car. Such a roof assembly may comprise a roof panel element made of glass and/or plastic, which is in particular a component of an adjustable cover element of a roof opening system, by means of which a roof opening can be selectively closed or opened. The roof panel element has a circumferential edge foam along its edges, which is formed from a polyurethane foam material and which, as an insert, accommodates an inner cover panel and thereby connects it to the inner side of the roof panel element facing the vehicle interior. In particular, in a rear region extending in the transverse direction of the roof, the inner cover panel has a leg which extends in the transverse direction of the roof and which is received by the edge foam via an edge region located on the outside relative to the center of the panel element. An edge located on the inside relative to the center of the panel element is exposed opposite the edge foam. Furthermore, this roof assembly may include a headliner comprising a headliner element that covers a roof frame area extending in the transverse direction of the roof at the bottom and that, in the closed position of the cover element, is spaced from the inner side of the roof panel element by an edge gap. Consequently, the panel edge formed by the exposed edge of the inner cover panel is visible from the vehicle interior, which may impair the visual appearance of the roof assembly.

Furthermore, it is known to equip roof panel elements of a motor vehicle roof assembly with a so-called ambient light functionality, which comprises a lighting device at each of the two lateral edge regions of the roof panel element, the light from which can be coupled into the roof panel element made of glass. For power supply, it is necessary for the lighting devices arranged on both sides to be connected in each case to a connection cable. To route a connection cable between the lighting devices arranged on both sides, it is known, for example, to form a cable channel in the edge foam. However, this involves high tooling costs during manufacturing.

The disclosure addresses the problem of creating a roof assembly designed in the manner described in the introduction, the visual appearance of which is improved compared to the state of the art described above.

This problem is solved according to the disclosure by the roof assembly having the features of claim 1.

According to the disclosure, a roof assembly for a motor vehicle is thus proposed, comprising a roof panel element made of glass and/or plastic, which is provided with a circumferential edge foam and to the inner side of which, facing a vehicle interior, an inner cover panel is attached, which has at least one leg extending in the transverse direction of the roof, having a first edge located outside relative to the center of the panel element, which is received by the edge foam, and a second edge located inside relative to the center of the panel element, which is exposed opposite the edge foam. In addition, the roof assembly comprises an interior headliner with a headliner element that forms a visible surface facing a vehicle interior and is spaced apart from the inner side of the roof panel element by an edge gap. A trim profile is mounted on the second, inner edge of the leg of the inner cover panel extending in the transverse direction of the roof and forms a further visible surface of the roof assembly in the area of the edge gap between the headliner element and the inner side of the roof panel element.

The trim profile thus serves as a covering for the edge of the inner cover panel formed by the second edge. This creates a visual appearance in the case of a partially foam-encased inner cover panel that is comparable to that of a roof panel element with a fully foamed inner cover panel. The trim profile is formed in particular from a plastic extrusion profile and is color-matched, for example, to the headliner element.

The roof panel element of the roof assembly according to the disclosure is preferably a component of an adjustable cover element of a roof opening system, wherein the leg of the inner cover panel extending in the transverse direction of the roof then preferably extends along the rear edge of the cover element or along the front edge of the cover element. In this case in particular, the headliner element, for example, constitutes a trim for a cross member of a roof frame. The trim may be a separately attached trim part or a molded material attached to the cross member, for example a polyurethane material, which forms the relevant visible surface of the roof assembly as seen from the vehicle interior.

The roof assembly according to the disclosure may, in particular, be designed as a panoramic roof that, in addition to the adjustable cover element, comprises a fixed roof element that is rigidly mounted relative to the vehicle body or a roof frame and, in the closed position of the cover element, is located at the rear of the cover element. In the open position, the cover element is at least partially displaced over the fixed roof element. A roof frame of such a panoramic roof may comprise two lateral longitudinal legs extending in the longitudinal direction of the roof, a front or bow-side cross leg, and a central cross leg that defines the rear boundary of the openable roof opening. In addition, the roof frame may optionally comprise a rear cross member.

The inner cover panel of the roof assembly according to the disclosure may be formed as a single piece. In particular, it may be a one-piece frame that is attached to the underside of the roof panel element by means of edge foaming. However, it is also conceivable that the inner cover panel is formed in multiple parts, wherein one of the parts is the cross member extending in the transverse direction of the roof, onto which the trim profile is mounted.

The visible surface of the headliner element is the surface that is exposed on the inner side of the roof, which delimits the passenger compartment of the vehicle in question, and may include surface areas that are oriented at any angle relative to the inner side or underside of the roof panel element or are aligned parallel to the inner side or underside of the roof panel element. Thus, side surfaces of the headliner are also included, the edge of which borders the edge gap located between the headliner element and the inner side of the roof panel element.

The roof panel element is preferably a component of a movable cover element of a roof opening system, but may alternatively also be a component of a so-called fixed transparent module (FTM), which is rigidly mounted relative to a roof substructure or a vehicle body and through which ambient light can enter the interior of the vehicle in question.

The roof transverse direction refers to the direction extending between the roof longitudinal edges, which in turn extend on the vehicle in question from a front roof cowl-which borders the top of a windshield-toward the rear of the vehicle. The center of the panel element refers to the region of the panel element that is located away from the edges, i.e., centrally relative to the base area of the panel element.

In a preferred embodiment of the roof assembly according to the disclosure, the trim profile, which is mounted onto the inner cover panel, comprises a fixing section into which the second edge of the leg of the inner cover panel extending in the transverse direction of the roof engages, and a support section that abuts the inner side of the roof panel element. In particular, the support section rests against the inner side of the roof panel element with a certain amount of preload, so that protection against flipping is ensured and tolerance compensation is also provided with respect to the distance between the second edge of the leg of the inner cover panel extending in the transverse direction of the roof and the inner side of the roof panel element. Thus, the inner cover panel does not need to be bonded to the roof panel element at the inner edge of the leg extending in the transverse direction of the roof.

In an advantageous embodiment of the roof assembly according to the disclosure , the support section of the trim profile of the roof assembly forms a channel for accommodating a cable. The trim profile can thus serve as a cable guide that accommodates, in particular, a connecting cable between the two edge regions of the roof panel element extending in the longitudinal direction of the roof.

The cable located in the channel of the support section is, in particular, a component of electrical systems associated with the roof panel element. For example, the roof panel element includes an ambient light feature with lighting fixtures arranged on both sides of the roof panel element’s edges-which extend in the longitudinal direction of the roof-relative to a vertical longitudinal center plane of the roof. However, it is also conceivable that the cable arranged in the channel of the support section is a component of an electrically switchable shading system that is integrated into the roof panel element and is designed as a PDLC (polymer-dispersed liquid crystal) array or an LC (liquid crystal) array. Furthermore, solar cells or anti-pinch systems to which the cable is assigned are conceivable as electrical devices.

As described above, the roof assembly according to the disclosure may comprise a lighting device associated with the roof panel element and configured as an ambient-light lighting device. In this case, preferably with respect to a vertical longitudinal center plane of the roof, a light source and a light-coupling device are provided on each side, which rests against the underside or inner side of the roof panel element and couples light from the light source into it. The roof panel element is, for example, designed as a laminated glass pane composed of several interconnected pane bodies. In this case, the pane forming the inner side of the laminated pane forms a light-guiding layer into which the light from the light sources can be coupled via the light-coupling devices. The light-coupling devices are, for example, each formed from several wedge-shaped, transparent plastic parts that are adhered to the underside of the roof panel element. The light sources, which may be configured as LED strips or PCBs (printed circuit boards) with a plurality of LEDs, are in contact with the light-coupling devices.

The support section of the trim profile configured according to the disclosure is preferably received by the inner cover panel, specifically by a channel-like profile section that is part of the leg of the inner cover panel extending in the transverse direction of the roof. In this case in particular, no cable routing is visible from the outside on the roof panel element of the roof assembly.

The disclosure also relates to a motor vehicle with a roof assembly of the type described above.

Further advantages and advantageous embodiments of the subject matter of the disclosure can be found in the description, the drawings, and the claims. The scope of the disclosure encompasses all combinations of at least two features disclosed in the description, the claims, and/or the figures; that is, any feature mentioned in the description or shown in the figures may, in and of itself, form part of the claimed subject matter, independently of the other features and/or embodiments mentioned or shown in the respective context.

### BRIEF DESCRIPTION OF DRAWINGS

An exemplary embodiment of a roof assembly according to the disclosure is shown schematically in the drawing and is explained in more detail in the following description. In the figures:

FIG. 1 shows a perspective top view of a roof assembly;

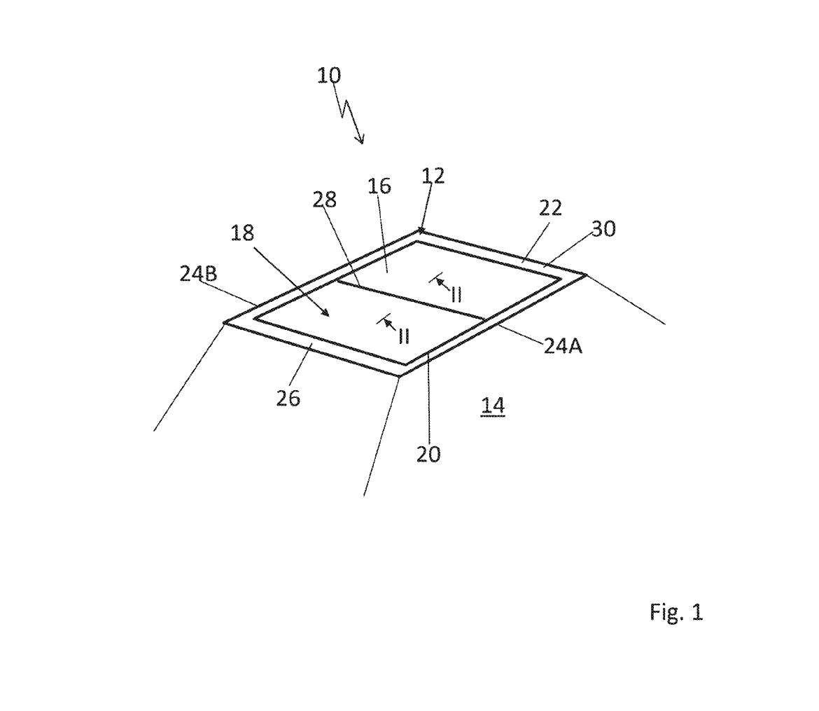

FIG. 2 shows a section through the roof assembly of FIG. 1 along line II-II in FIG. 1; and

FIG. 3 shows a perspective top view of a corner region of a roof panel element of the roof assembly according to the disclosure.

### DETAILED DESCRIPTION

The drawing shows a motor vehicle 10, which is designed as a passenger car and has a roof assembly 12 that defines the upper boundary of a vehicle interior 14.

The roof assembly 12 comprises a fixed roof element 16, which is rigid and thus non-displaceable relative to a roof substructure, and a cover element 18 arranged forward of the fixed roof element 16, which is part of a roof opening system and is adjustable between a closed position closing a roof opening 20 and an open position opening the roof opening 20. The roof substructure, relative to which the fixed roof element 16 is rigidly mounted and relative to which the cover element 18 is adjustable, comprises a roof frame 22, which includes two lateral longitudinal members 24A and 24B as well as a front, bow-side cross member 26, a centrally located cross member 28, which lies at the transition between the cover element 18 in its closed position and the fixed roof element 16, and a rear cross member 30. The two cross members 26 and 28 and the two longitudinal members 24A and 24B delimit the roof opening 20. The two cross members 28 and 30, together with the two longitudinal members 24A and 24B, define a rear frame window, which is closed off by the fixed roof element 16.

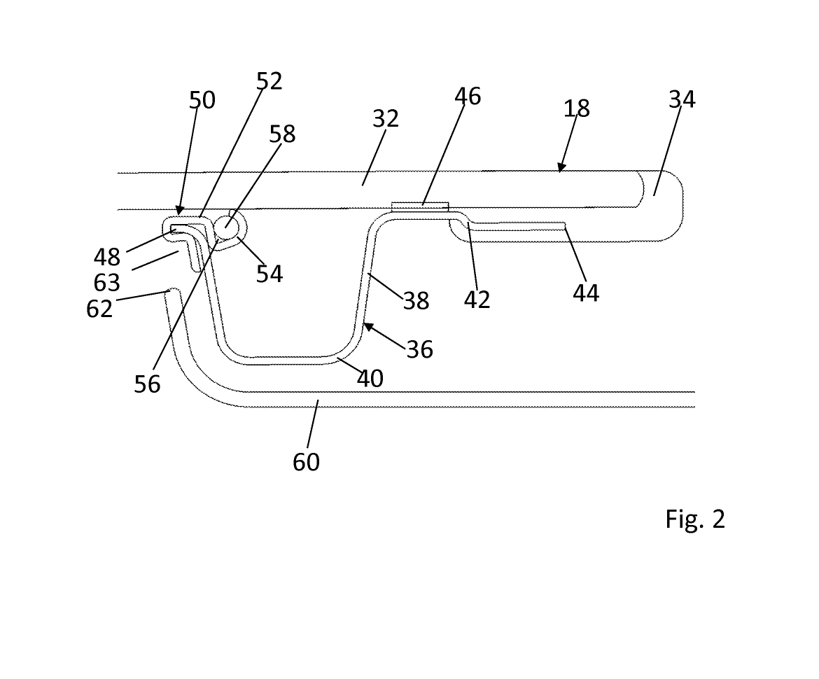

The cover element 18 comprises a roof panel element 32 made of glass, which has an at least approximately rectangular base area and is bounded at its edges all around by an edge foam 34 made of a polyurethane foam material. On its underside, the roof panel element 32 is provided with an inner cover panel 36, which is frame-like in design and comprises a leg 38 extending in the transverse direction of the roof, which is associated with a rear edge region of the cover element 18 and which, as can be seen in FIG. 2, has a channel-like profile region 40. In addition, the rear leg 38 of the inner cover panel 36, which extends in the transverse direction of the roof, features a panel section 42 on which a first edge 44 of the inner cover panel 36-located on the outside relative to the center of the panel element-is formed and which is received by the edge foam 34 in the manner of an insert. In addition, the panel section 42 is attached to the inner side of the roof panel element 32 via an adhesive strip 46.

A trim profile 50 is mounted onto, for example slotted toits second edge 48, which faces away from the edge 44; this trim profile extends substantially along the length of the leg 38 and is a plastic extrusion profile. The trim profile 50 comprises a fixing section 52 into which the second edge 48 of the leg 38 of the inner cover panel 36, extending in the transverse direction of the roof, engages, and a support section 54, which rests against the inner side of the roof panel element 32 from below and forms an upwardly open channel 56 for accommodating a cable 58. Via the trim profile 50 and its support section 54, the inner edge of the partially foamed leg 38, extending in the roof transverse direction, of the inner cover panel 36 can be supported against the inner side of the roof panel element 32.

The middle cross member 28 of the roof frame 22 is provided with a headliner element 60 having a cross-section that is substantially trough-shaped, which forms an inner visible surface of the roof assembly 12 facing the vehicle interior 14. The headliner element 60 has a front edge 62 which, in the closed position of the cover element, is spaced from the inner side of the roof panel element 32 by an edge gap 63. The trim profile 50 forms a visible surface in the region of this edge gap, which is visible from the vehicle interior 14.

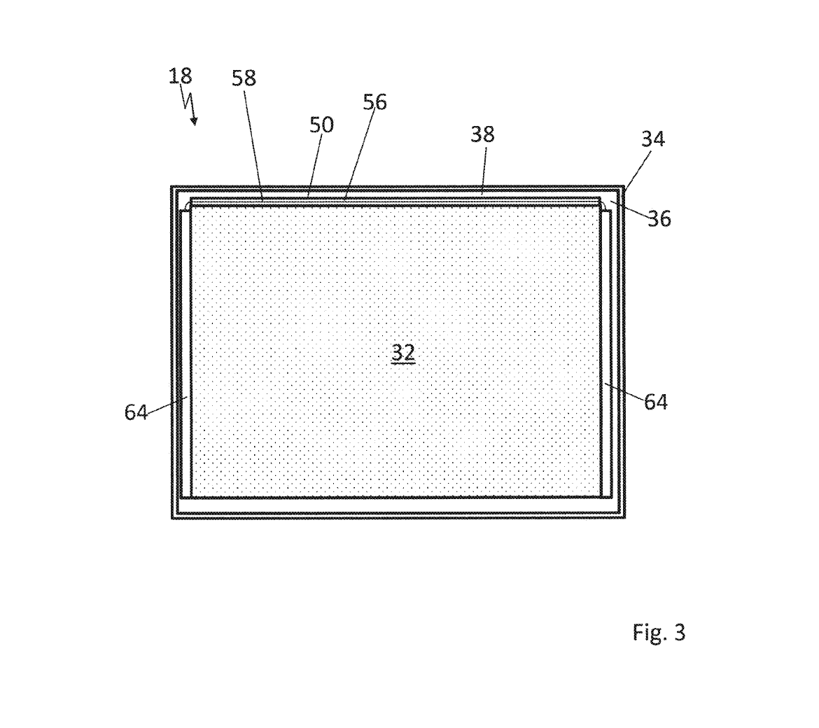

As can be seen in FIG. 3, the cable 58, which is routed in the channel 56, is connected on both sides to ambient-light lighting 64 of the cover element 18, which extends along the two longitudinal edges of the roof panel element 32. The trim profile 50 thus serves, on the one hand, as a guide element for the cable 58 that is not visually discernible from the outside and, on the other hand, as a trim piece that, when the cover element 18 is in the closed position, ensures a visually appealing appearance of the roof assembly 12 from the vehicle interior 14 in the area of the edge gap between the headliner element 60 and the roof panel element.

### LIST OF REFERENCE SIGNS

10 Motor vehicle
12 Cover assembly
14 Vehicle interior
16 Fixed roof element
18 Cover element
20 Roof opening
22 Roof frame
24 A, B Longitudinal beam
26 Cross member
28 Cross member
30 Cross member
32 Roof panel element
34 Edge foam
36 Inner cover panel
38 Leg
40 Profile region
42 Panel section
44 Edge
46 Adhesive strip
48 Edge 50 Trim profile
52 Fixing section
54 Support section
56 Channel
58 Cable
60 Headliner element
62 Edge
63 Edge gap
64 Ambient-light lighting

1. A roof assembly for a motor vehicle, comprising:
a roof panel element made of glass and/or plastic, which is provided with a circumferential edge foam and to the inner side of which, facing a vehicle interior, an inner cover panel is attached, which has at least one leg which extends in the transverse direction of the roof and which has a first edge located on the outside relative to the center of the panel, which first edge is received by the edge foam, and a second edge located on the inside relative to the center of the panel element, which second edge is exposed opposite the edge foam,
further comprising a headliner with a headliner element that forms a visible surface facing a vehicle interior and is spaced apart from the inner side of the roof panel element by an edge gap,
wherein a trim profile that is mounted onto the second, inner edge of the leg of the inner cover panel extending in the transverse direction of the roof and forms a visible surface of the roof assembly in the region of the edge gap between the headliner element and the inner side of the roof panel element.

2. The roof assembly as claimed in claim 1, wherein the trim profile comprises a fixing section into which the second edge of the leg of the inner cover panel extending in the transverse direction of the roof engages, and a support section that abuts the inner side of the roof panel element.

3. The roof assembly as claimed in claim 2, wherein the support section forms a channel for receiving a cable.

4. The roof assembly as claimed in claim 3, wherein the inner cover panel comprises a channel-like profiled region in which the channel of the support section is at least partially accommodated.

5. The roof assembly as claimed in claim 1, wherein the roof panel element is a component of a movable cover element of a roof opening system.

6. The roof assembly as claimed in claim 5, wherein the leg of the inner cover panel extending in the transverse direction of the roof, onto which the trim profile is mounted, is arranged at a rear edge of the cover element.

7. The roof assembly as claimed in claim 1, wherein the headliner element covers the inner surface of a cross member of a roof frame.

8. A motor vehicle comprising a roof assembly according to claim 1.
